(19) United States
(12) Patent Application Publication
(10) Pub. No.: US 2006/0013077 A1
(43) Pub. Date: Jan. 19, 2006

(54) Audio-video systems with application specific modules and common processing software architecture

(76) Inventors: Vladimir Z. Mesarovic, Austin, TX (US); Sachin Deo, Kothrud (IN); Christopher L. Jackson, Austin, TX (US)

Correspondence Address: HAMILTON & TERRILE, LLP, P.O. BOX 203518, AUSTIN, TX, 78720, US

(21) Appl. No.: 10/776,295

(22) Filed: Feb. 11, 2004

(51) Int. Cl. G11B 21/08

(52) U.S. Cl. 369/30.01

(57) ABSTRACT

An audio/visual (A/V) system utilizes a software architecture partitioned between application specific code and common processing code. For example, in an audio context, decoder code represents an embodiment of application specific code and post-processing operations such as bass control, tone control, volume control, and mute represent common processing code. The A/V system also utilizes a RISC processor to control communication between a digital signal processor (DSP) and peripheral devices. A/V system 300 uses a first-in-first-out (FIFO) memory buffer to store communications between the RISC processor and DSP. The FIFO is preferably sufficiently large to allow the RISC processor and DSP to operate at their own respective paces. A/V system 300 also utilizes a standard command word and a manager for each DSP application that allows the RISC and DSP to easily exchange information.

### BACKGROUND OF THE INVENTION

1. Field of the Invention

The present invention relates in general to the field of information processing, and more specifically, to an audio-video processing system and method employing a software architecture logically partitioned between common processing software and application specific software.

2. Description of the Related Art

The technology of audio/visual (A/V) systems continuously advances. For example, video cassette players (VCPs) process analog signals from a tape medium. Digital versatile disk (DVD) players succeeded VCPs and process digital signals from a DVD medium. The introduction of DVD players also introduced a DVD data format that provided both superior video and audio quality as compared to the previous VCP format. As signal processing moves into the digital realm, the quality and sophistication of audio and video signal processing continues to advance as well.

FIG. 1A depicts an early representation of a digital audio/video system 100, such as a DVD player. Initial A/V systems distributed video and audio signal processing to two physically distinct components. Video system components process video signals, and audio systems process the audio signals. The digital A/V system 100 receives an A/V input data signal 104 from signal source 103, such as a DVD disc. The A/V input data signal 104 contains video information formatted in accordance with moving picture experts group—layer 2 (“MPEG-2) and audio information in one of a limited number of formats, such as MPEG-2, Dolby Digital®, or pulse code modulation (“PCM”). A demultiplexer 105 separates the audio and video portions of the A/V input data signal 104. The video decoder 107 decodes the video portion of input data signal 104 and provides video output signal 111 to a display device, such as a television. The audio decoder 109 detects the format of the audio portion of input data signal 104 and processes the audio portion in accordance with the detected format. In addition, the audio decoder performs post-processing operations, such as bass management, volume control, and tone control.

FIG. 1B depicts the audio decoding and post processing software architecture 11 of digital A/V system 100. Initially, digital A/V system 100 typically supported only one audio compression algorithm, such as Dolby Digital. Furthermore, digital A/V system 100 performed a very limited amount of audio signal post-processing. Accordingly, only a limited amount of post processing code, such as bass management, tone control, and mute management, was custom developed for each audio decoder. As the complexity of audio signals, audio system features, and processing technology increased, A/V system 100 became responsible for an increasing number of post-processing operations. As the number of audio decoders increased to support the multiple advanced audio signal formats, the one-to-one close coupling between post-processing code and decoder code continued. Some of the major post-processing operations currently include: audio management (volume control, delays, channel remapping, and de-emphasis), bass management, tone control, equalization, dynamic range compression, sample rate conversion, and surround effects modes. Thus, as audio decoders and post processing operations incrementally increased, digital A/V system 100 developers held to the software architecture 116 depicted in FIG. 1B.

Data storage device 108 stores the software audio decoder codes 1 through N (1:N) and post-processing code 1:N. Software decoder codes 1 through N (1:N) each correspond to a particular audio signal decoder format. Audio decoder codes may also be implemented in firmware or as a combination of firmware and software. The audio decoder processor 109 accesses the audio decoder code corresponding to the detected compression format to decode (also referred to as “decompress”) the audio data from input data signal 104. The audio processor 112 accesses the post-processing code associated with the accessed audio decoder code to perform post-processing operations on audio signal 110. The post-processing codes 1:N provide instructions and data to allow audio processor 112 to perform the post-processing operations.

The post-processing code 1:N also may support multi-channel audio formatted signals using audio matrix decoders and virtualizers. When the audio signal 110 has 2-channels, matrix decoding effectively increases the number of input channels using channel expanding algorithms. ProLogic®, Pro Logic®-II, Pro Logic® IIx, Neo:6™, Circle Surround®, and Circle Surround®2 formats, represent proprietary matrix post-processing algorithms embodied in post-processing code (ProLogic is a registered trademark of Dolby Laboratories, Inc.; Neo:6 is a trademark of Digital Theater Systems, Inc. Circle Surround is a registered trademark of SRS Labs, Inc.). Virtualizers reduce the number of audio input channels in audio signal 110 when audio equipment supports a lower number of channels. For example, many televisions and audio systems only support 2-channel stereo sound and do not support 5.1 or 6.1 surround sound. Exemplary virtualizers include SRS Tru-Surround®, Spatializer N-2-2™, Q-Sound®, Cirrus® Virtualizer, and Dolby® virtual speaker (DVS)/Dolby® virtual headphone (DVH) virtualizers Tru-Surround is a registered trademark of SRS Labs, Inc.; Spatializer N-2-2 is a trademark of Desper Products, Inc.; Q-Sound is a registered trademark of Archer Communications, Inc.; Cirrus is a registered trademark of Cirrus Logic, Inc.; and Dolby is a registered trademark of Dolby Laboratories, Inc.).

Referring to FIG. 2, high-end DVD decoder 200 combines the operations of an audio system and a DVD player via separate video and audio decoder devices, although the separate video and audio decoder components of digital A/V system 100 are relatively expensive to produce. DVD decoder 200 includes video decoder 202 to decode the video portion of input data signal 104. Audio digital signal processor 206 processes the audio portion of input data signal 104. The DVD decoder 200 provides a larger array of signal processing capabilities relative to earlier systems. For example, the audio decoder provides six to eight audio channel output signals 210 and can also support advanced audio algorithms, such as Dolby® Digital EX, Advanced Audio Coding (AAC™), Windows Media® Audio (WMA), Windows® Wave (WAV), Digital Theatre Sound (DTS®) Digital Surround, Dolby ProLogic® II, virtualizers, and multiple surround modes, such as music hall, theater, and stadium (AAC is a trademark of Dolby Laboratories, Inc.; Windows and Windows Media are registered trademarks of Microsoft Corporation; DTS is a registered trademark of Digital Theater Systems, Inc.).

Despite hardware differences between digital A/V system 100 and DVD decoder 200, DVD decoder 200 retains the close coupling between decoding software code and post-processing code. This closely associated software architecture naturally followed from the conventional architecture to associate extensions of decoder and post processing signal processing capabilities. As the amount of post processing operations increased for each audio decoder 1:N, developers added customized code for each 1:N post processing operation resulting in N blocks of decoder/post processing code.

Thus, the amount of post processing code multiplied over time as the number of decoders increased. Similarly, if new IC hardware upgrades are pursued for reasons, such as cost reduction and improved speed/functionality, the number of decoders and post-processors multiply with the number of platforms if firmware/software compatibility is not maintained. Furthermore, developers add more post processing operations per decoder. The methodology of developing customized post processing code for each decoder results in a substantial amount of development and integration time. Additionally, maintaining an expanding code base increases maintainability and reliability problems. Nevertheless, in the absence of an alternative, the conventional methodology and software architecture dictates repetitious development efforts and places further pressure on development, maintenance, and support resources.

### SUMMARY OF THE INVENTION

An audio/visual (A/V) system utilizes a software architecture partitioned between application specific code and common processing code. In one embodiment of the present invention, an audio-video signal processing system having a partitioned software architecture includes a processor and a processor readable medium coupled to the processor, the processor readable medium having signal processing to process an input signal. The signal processing code includes application specific code comprising a plurality of application specific modules, wherein each application specific module includes code to cause the processor to perform at least one operation and common processing code comprising a plurality of common processing modules, wherein each common processing module includes code to cause the processor to perform at least one operation and each common processing module is compatible with a plurality of application specific modules.

In one embodiment of the present invention, a method of processing data using a processor and software architecture partitioned between application specific modules (ASMs) and common processing modules (CPMs) includes receiving input data and requesting one of the ASMs to perform an operation on the input data. The method further includes performing the operation using the requested ASM, requesting one of the CPMs to perform a common processing operation, wherein each of the CPMs is compatible with a plurality of the ASMs, and performing the common processing operation using the requested CPM.

In one embodiment of the present invention, an audio/visual system having a software architecture partitioned between application specific modules (ASMs) and common processing modules (CPMs) includes means for receiving input data and means for requesting one of the ASMs to perform an operation on the input data. The system also includes means for performing the operation using the requested ASM, means for requesting one of the CPMs to perform a common processing operation, wherein the CPMs are compatible with a plurality of ASMs, and means for performing the common operation using the requested.

In one embodiment of the present invention, a method of developing a segmented software architecture for an audio/video system includes partitioning software into application specific code and common processing code to cause one or more audio/video processors of the audio/video system to perform predetermined operations. Partitioning the software includes generating a plurality of application specific modules, wherein each application specific module consolidates unique code used for at least one of the processor operations and generating common processing modules that are compatible with a plurality of application specific modules for performing operations in conjunction with a plurality of application specific modules.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1A (prior art) depicts a digital audio/visual system.

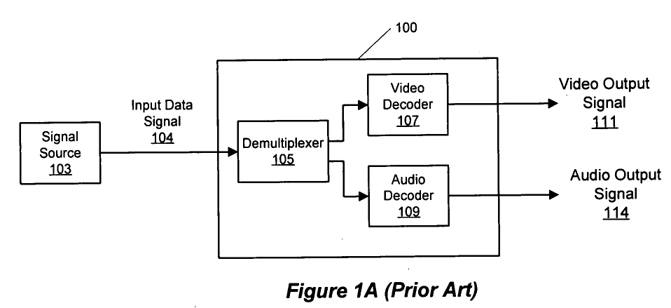

FIG. 1B (prior art) depicts a digital audio/video system for processing audio/visual signals with a one-to-one decoder/post-processing code software architecture.

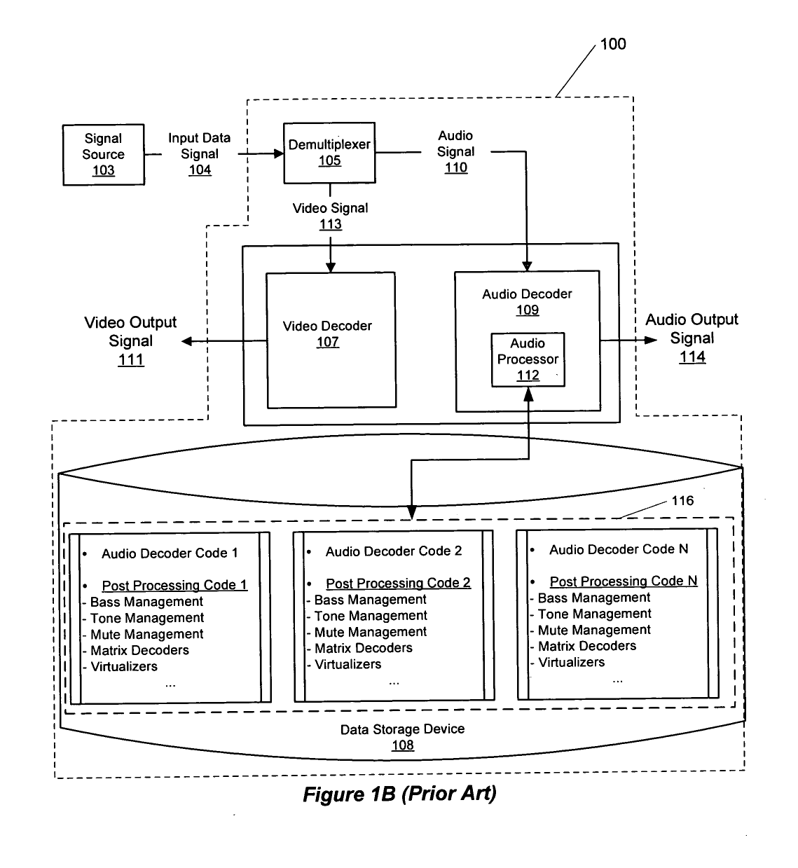

FIG. 2 (prior art) depicts a DVD/audio system with separate audio and visual decoder components for processing audio/visual signals with a one-to-one audio decoder/post-processing code software architecture software.

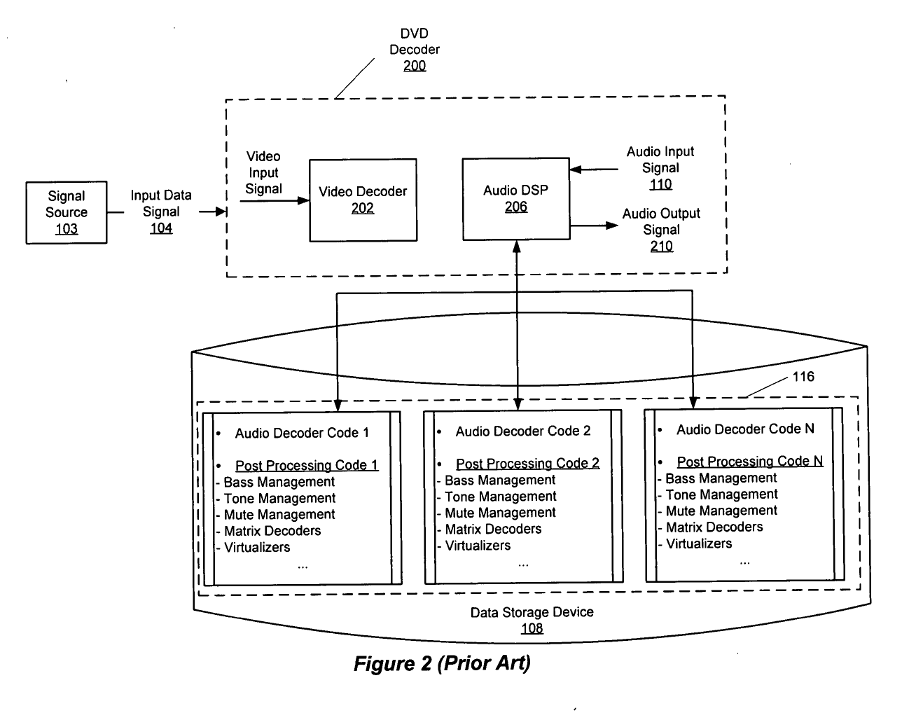

FIG. 3 depicts an audio/visual system having an integrated audio/visual processor and a partitioned application specific code and common processing code software architecture.

FIG. 4 depicts an audio signal processing context of the software architecture of FIG. 3.

FIGS. 5A and 5B depict a command and data communication structure of application programmer interface for the audio/visual system of FIG. 3.

FIG. 6 depicts a local manager table.

FIG. 7 depicts a command data structure word.

FIG. 8 depicts a software architecture that partitions application specific modules and common processing modules.

FIG. 9 depicts an audio/visual system with the software architecture of FIG. 8 that further partitions the common processing modules.

### DETAILED DESCRIPTION

As audio/visual (A/V) systems support a growing number of audio signal formats and post processing operations, a new A/V system software architecture logically segments common processing operations from application specific processing operations. An application specific processing operation represents an operation undertaken based upon a particular type of signal being processed. The format of a signal represents one particular signal type. Audio decoders represent instances of application specific processing operations. Each audio decoder includes a unique set of algorithms to decode a specific audio signal format. For example, the following audio formats each utilize a code implementation having a unique set of algorithms: Dolby® Digital, Dolby® Digital EX, DTS® Digital Surround, DTS-ES, Meridian Lossless Packing (MLP Lossless™), MPEG-½ Layer I, II, MPEG- 2/4 Advance Audio Coding (AAC™), WMA, PCM, High-Definition Compact Disc (HDCD®) (MLP Lossless is a trademark of Dolby Laboratories, Inc.). Each application specific processing operation is implemented using software and/or firmware referred to as an application specific module (ASM). The term “module” includes any code embodiment, such as routine-subroutine techniques and object-oriented programming techniques.

Common processing operations represent operations that are not necessarily dependent upon a signal type. Common processing operations may be utilized in conjunction with other processing operations, such as multiple application processing operations or other common processing operations. For example, many audio decoders utilize many of the same audio post processing operations. Some of the major common audio post processing operations are audio management (volume control, delays, channel remapping, de-emphasis), bass management, tone control, equalization, dynamic range compression, sample rate conversion, surround effects modes, matrix decoders, and virtualizers. Each common processing operation is implemented using software and/or firmware referred to as a common processing module (CPM).

Conventionally, the number of code modules required to perform application specific and common processing operations equaled the total number of ASMs times the total number of CPM combinations. The complexity of a conventional audio system increases quadratically with the increase in number application specific modules and common processing modules.

The ASM-CPM software architecture 304 logically segments application specific modules from common processing modules. The common processing modules are each compatible with all of application specific modules. By segmenting ASM modules from common processing into the partitioned ASM-CPM software architecture 304 and developing common processing modules with cross-ASM compatibility, the number of code modules used to perform ASM and common processing operations can be reduced to the total number of ASMs plus the total number of CPMs. The number of CPMs actually loaded into system memory can be reduced by restricting the number of loaded CPMs to CPMs needed to support on-demand processing operations. The ASM-CPM software architecture 304 can reduce costs associated with A/V system software development and maintenance costs while increasing reliability and maintainability. Additionally, ASM-CPM software architecture 304 simplifies processor control code and simplifies adding and porting common processing modules. As the number ASMs and CPMs grow, the complexity increases linearly, which provides an advantage of the ASM-CPM partitioned software architecture.

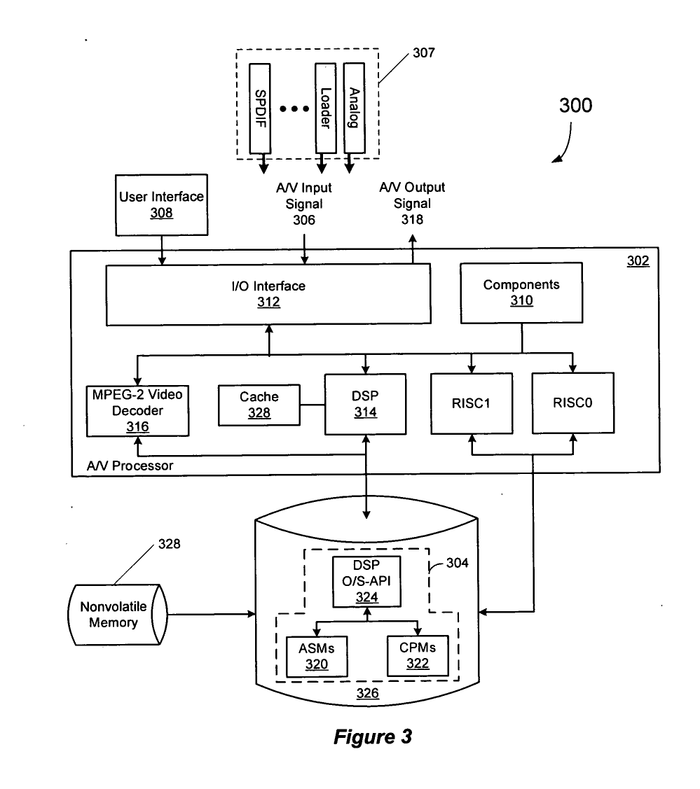

Referring to FIG. 3, A/V system 300 includes A/V processor 302 and A/V software 304 to process A/V input signals and provide A/V output signals. One embodiment of A/V system 300 is described in “Design of a DVD-AV Receiver Using a Single-chip DVD Processor” by V. Mesarovic and K. Konstantinides, May 2003 issue of IEEE Transactions of Consumer Electronics, Volume 49, Number 2 (ISSN 0098-3063), May 2003, pp 388-392, which is incorporated herein by reference in its entirety. Another embodiment of A/V processor 302 is the CS98200 series of DVD processors available from Cirrus Logic, Inc. of Austin, Tex.

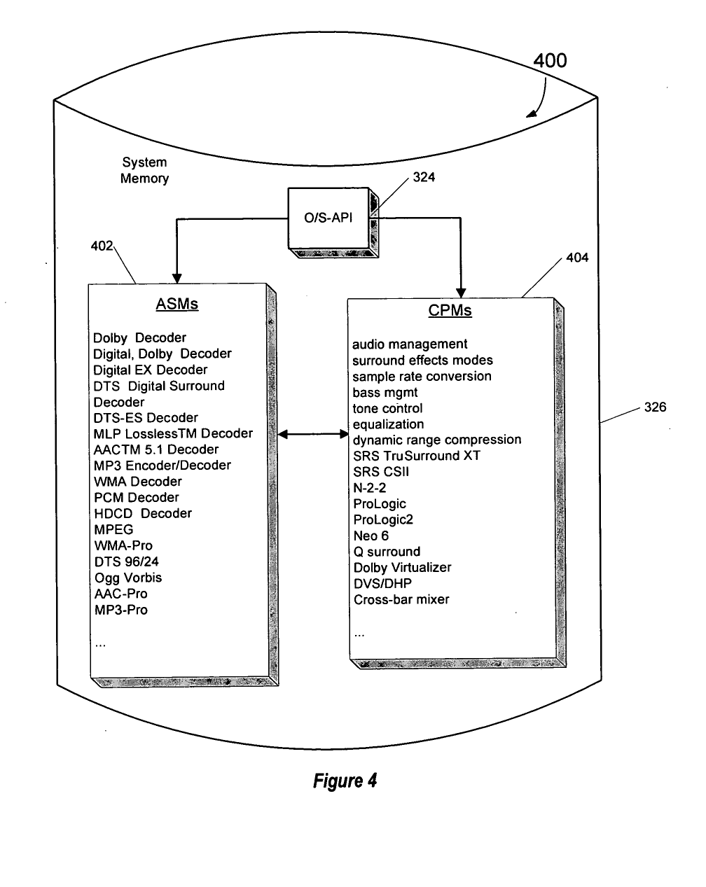

A/V processor 302 integrates a number of hardware and software components to process input signals and generate an output signal. The A/V system 300 divides data processing among several hardware, firmware, and software components. A/V system 300 includes an application programmer interface (API) and operating system (OS) that allow hardware components to communicate with and utilize the ASM-CPM software architecture 304 while avoiding data errors associated with read/write race conditions. The A/V input signal 306 can include an audio signal, a video signal, or a combined audio/visual signal (A/V signal) 307. A/V input signal 306 can be analog or digital and can be provided by any audio and/or video source such as a DVD/CD loader, an ITU-656 compliant digital video source, or Sony/Philips digital interface (S/PDIF)) compliant source. A/V processor 302 also receives input from user interface 308. User interface 308 receives user commands such as volume control, speaker setup/configuration, mute, bass control, equalization, and surround modes via direct (such as front panel control) or remote control mechanisms. The components 310 provide the additional operations not explicitly depicted in FIG. 4 that enables the A/V processor 302 to process video and audio signals. The components 310 can include a video-graphics processor with multiple video digital to analog converters, sub-picture decoder with a special co-processor for MPEG-4 video decoding, memory control, and clock operations. The I/O interface 312 can include any number of I/O interface components to receive the A/V input signal 306 in accordance with the type and format of the A/V input signal 306. For example, I/O interface 312 can include a DVD Loader I/O interface to receive DVD and CD input signals, a video interface to receive ITU 656 compliant digital video signals, and an audio interface to receive analog and/or digital audio input signals.

The A/V processor 302 integrates two MIPS™—like 32-bit reduced instruction set computer (RISC) processors, RISC0 and RISC1. Processor RISC0 runs a real-time operating system (RTOS) and performs real-time, critical, audio and video services and low-level operations (MIPS is a trademark of MIPS Technologies, Inc.). For example, the processor RISC0 coordinates on-chip multi-threaded tasks, as well as system activities, such as remote control and front panel control. The RISC processors are responsible for all front-end processing, such as host interfacing, loading, media navigation, data retrieving, demultiplexing, and video and audio processing scheduling. A/V processor 302 also includes a digital signal processor (DSP) 314, which, in one embodiment, is optimized for audio processing applications. Processor RISC1 can be used for custom applications and controls.

The DSP 314 performs audio signal decoding and audio post-processing operations. Compressed audio data is made available to DSP 314 by any desired ways such as through a flexible hardware accelerated (bit-ripper) direct memory access (DMA) process from the external memory. The DSP 314 generally uses local memory for audio signal decoding. If local memory space cannot accommodate the decoding process, then additional space is available in the system memory 326. A/V processor 302 loads code from nonvolatile memory 328 into system memory 326 for better access performance. A/V processor 300 provides output data in a standard format, such as pulse code modulation (PCM). Decoded and post-processed PCM samples are transferred to an output port as A/V output signal 318 in which dedicated PCM hardware maintains synchronous playback.

The ASM-CPM software architecture 304 separates application specific processing code from common processing code by dividing ASMs 320 (collectively referred to as “application specific code”) from CPMs 322 (collectively referred to as “common processing code”). System memory 326 and nonvolatile memory 328 store the application specific code and cross-compatible common processing code using any suitable memory type. System memory 326 is generally volatile memory, such as synchronous dynamic random access memory (SDRAM). “System memory” is also often referred to by other terms, such as main memory and working memory. Cache memory can also be used to store all or part of the application specific code and cross-compatible common processing code.

Software architecture 304 can share all ASMs 320 and CPMs 322. However, because of the segmented nature of software architecture 304, ASMs 320 can be added without affecting the CPMs 322 and vice versa. Thus, compilation, development, and maintenance times can be reduced relative to conventional technology.

FIG. 4 depicts the partitioning of operations in software architecture 400 between ASMs 402 and CPMs 404 in an audio signal processing context.

A/V system 300 divides audio messaging and processing operations between the RISC0 processor and DSP 314. All system and user communication with the DSP 314 is streamlined through the RISC0 processors. The API 324, stored in system memory 326, provides a very efficient command and data communication and allows for developers to program the audio DSP 314 without affecting the rest of the A/V system 300. The RISC-to-DSP application programmer interface (API) 324 standardizes handling of all audio formats. The processor RISC0 and DSP 314 exchange information, which enables utilization of DSP 314 through API 324. Communication is implemented through a command FIFO and through ASM and CPM “managers.”

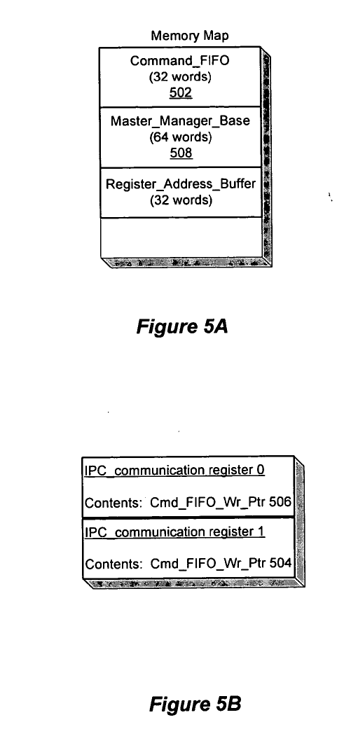

FIGS. 5A and 5B depict the command and data communication structure of API 324. In addition to using a partitioned software architecture, an A/V system utilizes a RISC processor to control communication between a DSP and peripheral devices. A/V system 300 uses a first-in-first-out (FIFO) memory buffer to store communication messages between the RISC processor and DSP. The FIFO is preferably sufficiently large to allow the RISC processor and DSP to operate at their own respective paces. A/V system 300 also utilizes a manager for each DSP application that allows the RISC and DSP to easily exchange information. The circular command FIFO registers 502 facilitate control and status messaging between processor RISC0 and DSP 314, which avoids slowing down processor RISC0. In one embodiment, the command FIFO 502 is thirty-two (32) words deep and allocated at a fixed location in system memory 326. DSP 314 owns and maintains a command FIFO read pointer, Cmd_FIFO_Rd_Ptr 504. ProcessorRISC0 owns and maintains a command FIFO write pointer, Cmd_FIFO_Wr_Ptr 506. To eliminate slower SDRAM access, interprocessor communications register, IPC_communication Reg 0 stores the value of Cmd_FIFO_Wr_Ptr 506, and interprocessor communications register, IPC_communication Reg 1 stores the value of Cmd_FIFO_Rd_Ptr 504.

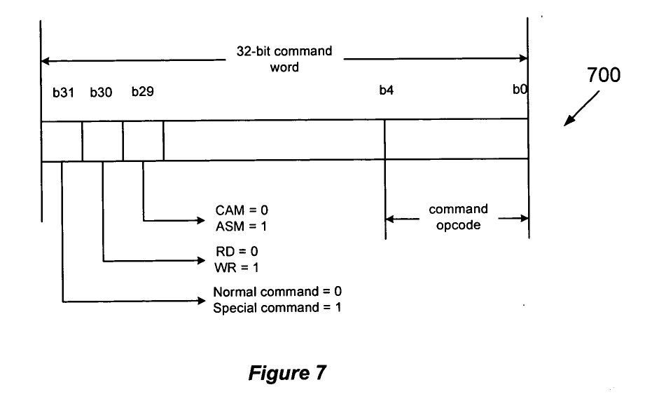

When processor RISC0 writes a command into the FIFO 502, processor RISC0 updates the Cmd_FIFO_Wr_Ptr 506. When DSP 314 reads the command, DSP 314 updates Cmd_FIFO_Rd_Ptr 504. DSP 314 determines that a new command is available if Cmd_FIFO_Rd_Ptr 504 is less than Cmd_FIFO_Wr_Ptr 506. In other embodiments, the size of FIFO 502 can be adjusted to accommodate the relative speed and activity of processor RISC0 and DSP 314. The entries of Table 1 represent an example of read and write commands. The last bit represents the common processing module or application module. Table 2 and FIG. 7 depict the command data structure. Each of ASMs 320 and CPMs 322 is assigned a unique opcode within ASM and CPM groups, respectively. For example, an Audio Manager represents a common processing module with an opcode of 00001b (“b” represents binary), and DTS represents an application specific module with an opcode of 00002b.

TABLE 1

| | COMMAND | |
|---|---|---|
| COMMAND | (hexadecimal | |
| TYPE | format) | EXPLANATION |
| write CPM | 40000001 | write to Audio Manager. |
| read CPM | 00000001 | read from Audio Manager. |
| write ASM | 60000002 | write to DTS manager. |
| read ASM | 20000002 | read from DTS manager. |

User commands are received by processor RISC0, and processor RISC0 communicates the appropriate information to DSP 314. Exemplary user commands are: play, stop, pause, fast-forward and fast-rewind. Messages can be either of a write or a read type. Additionally, developers can also communicate with the DSP 314 through processor RISC0 and DSP 314. For example, loading a new set of filter coefficients for a post-processing module is carried out through a write message from the processor RISC0 to DSP 314. Messages from DSP 314 can also be communicated to a user. For example, posting bit stream parameters (such as sampling frequency and input channel configuration) on a front-panel of A/V system 300 is carried out through a read message from the DSP 314.

A/V system 300 controls and monitors ASMs 320 and CPMs 322 through groups of status registers/fields referred to generically as “managers”. The processor RISC0 communicates with DSP 314 by placing a command word in the command FIFO that specifies a modification of the appropriate manager register(s). DSP 314 receives notification of the processor RISC0 message by checking the Cmd_FIFO_Rd_Rtr 504 against the Cmd_FIFO_Wr_Ptr 506. Each ASM and CPM is associated with a specific manager. For flexibility in assigning memory locations within system memory 326, a master_manager_base 508 stores the base addresses of the managers in a predetermined, fixed location memory buffer. In an alternative embodiment, the managers are stored in a fixed memory location. The size of the memory buffer depends upon the number of managers and expected increase in the number ASMs and CPMs. In one embodiment, A/V system 300 reserves memory addresses for 64 managers, 32 CPM managers and 32 ASM managers.

A/V system 300 shares all CPM managers and utilizes all ASM managers in a uniform manner across all DSP applications. In other words, CPM managers are accessed/shared in the same way as ASM managers. This greatly simplifies the control code on the processor RISC0 side and makes adding/porting of these common-processing modules very easy.

Each CPM manager stores operational data, such as operational parameters and configuration attribute values. DSP 314 uses the data in a CPM manager to perform the operations of the associated CPM. For example, in an audio signal processing environment, a CPM manager can store operational codes for specifying different modes for channel matrix decoding/encoding, sound virtualization, filtering and content rerouting, and equalization. A more specific example is an Audio Manager, which stores data including individual channel delay parameters, volume control, downmixing, dynamic range control (DRC), and de-emphasis parameters. Control variables of each manager have an enable/disable control bit and a parameter configuration portion through which operations are maintained. User selections via buttons on an A/V system 300 front panel and/or remote can translate to a set of variables stored in a CPM manager. A CPM manager can be any desired size, from a single variable/register or a group of hundreds or more variables/registers. Multiple CPM managers can be active while running any of the ASMs 320. The variety of CPM managers is within the control of the developer of the A/V system 300 and adds flexibility and breadth of capability to A/V system 300. CPM managers also allow manufacturers to differentiate from their competitors by adding custom features, such as custom surround sound processing modes on the back end of decoders.

The ASM managers perform a operation for the ASM modules similar to the role of the common processing managers. In one embodiment, the ASM managers are decoder specific and are active in time-multiplexed fashion, that is, assuming that only one thread of a decoder is running, only one ASM manager is active in system memory 326 and local cache memory at the same time. This is sufficient for all typical applications, as users are playing only one DVD disc at a time and only one audio source is decoded in the A/V system 300. Audio related ASM managers typically contain audio signal bit stream information, such as sampling frequency, input channel configuration, source PCM precision, and bit rate of a compressed data.

Since the DSP 314 and processor RISC0 are both reading and writing to FIFO registers 502, A/V system 300 avoids race conditions in writing and reading managers by maintaining a master copy of the manager (referred to as “global managers”) in system memory 326, and local managers are maintained in the local DSP CACHE 328. When processor RISC0 changes one or more master manager(s) in system memory 326, processor RISC0 notifies DSP 314. DSP 314 copies from system memory 326 to local cache 328 those manager(s) that changed and acknowledges to processor RISC0 receipt of the change. Alternatively, DSP 314 can make a copy of the global managers within system memory 326 and utilize the copy. The usage is both design and application dependent of DSP 314, and, in one embodiment, is transparent to the RISC programmer/system user.

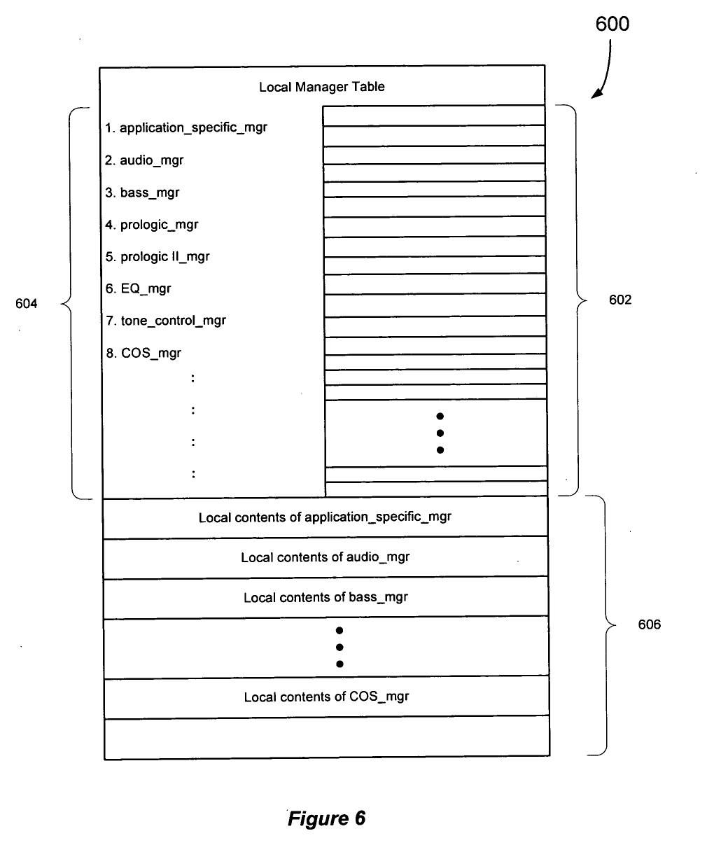

FIG. 6 depicts a local manager table 600. The local manager table includes a block of memory 602 with one or more fields allocated to each local manager entry 604. The depth of local manager table 600 equals the number of ASM and CPM managers. Each manager index includes two table entries (rows). The first entry is an address field and size field packed in upper and lower portion of 16 bit words respectively, and the next entry is the read size and write size of each manager packed in upper and lower 16 bit words respectively. The address field denotes where in local cache the local copy of a manager resides, the size field gives the total size of the manager in words, and read and write sizes are used for the aid of read and write command from the processor RISC0. The local content 606 of each manager is stored in another block of memory.

FIG. 7 depicts an example command data structure word 700 that allows the processor RISC0 to communicate with the DSP 314 through the common processing managers and ASM managers. A command data structure is a matter of design choice appropriate to the particular A/V system 300. The command data structure word 700 is a 32-bit word that utilizes various predetermined bit positions to identify the nature of the command and the target of the command. Table 2 sets forth the organization of command data structure word 700.

TABLE 2

| Bit Position | Interpretation |
|---|---|
| b31 | 0 = Normal Command |
| | 1 = Special Command. |
| b30 | 0 = Read command |
| | 1 = Write command. |
| b29 | 0 = CPM manager |
| | command |
| | 1 = ASM manager |
| | command. |
| b28-b5 | Reserved |
| b4-b0 | Command opcode |

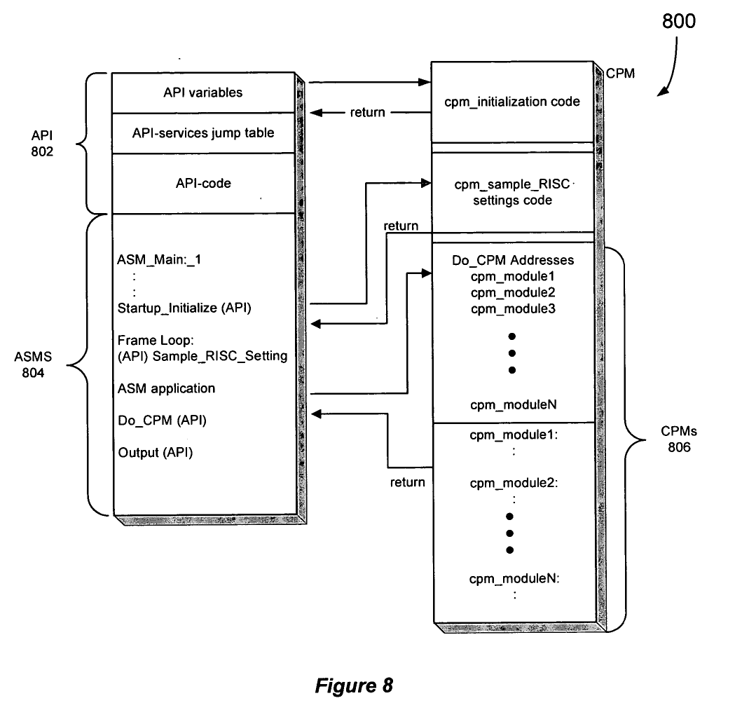

FIG. 8 depicts software architecture 800, which is one embodiment of software architecture 304. In addition to ASMs and CPMs, the software architecture 800 also includes a representation of API 802. The API 802 provides the interface into ASMs 804 and CPMs 806 that allow ASMs and CPMs to be used by developers without an intricate knowledge of the ASMs 804 and CPMs 806. The API 802 includes API variables, such as platform identification information, number of output channels, status registers, interrupt registers, and other data utilized to interface with A/V system 300. API services include initializing local managers, setting up the FIFO interfaces and PCM control registers, updating ASMs, detecting sampling frequency changes and interrupts, and detecting data underflow. The API service jump table is a table with addresses of all current API services provided. These services (e.g. subroutines) can be called at any time by the API and/or decoder and generally serve as common system operations for the decoder. The API services can be easily upgraded individually and new ones can be easily added.

During start-up, variables used by any of the CPMs 806 and stored by the API 802 are transferred to the CPM_initialization code block. The Sample_RISC_settings is one of the services (subroutines) of API 802 and operating system that periodically checks to determine if any pending messages from processor RISC0. If so, this subroutine copies the new global manager settings to local managers. Additionally, the operating system loads the local manager copy with corresponding data and sets Cmd_FIFO_Rd_Ptr 404 and Cmd_FIFO_Wr_Ptr 406 to the same value. Default values are loaded into the global and local managers.

Upon completion of the initialization of A/V system 300 and upon receipt of an A/V input signal 306, the processor RISC0 loads the appropriate DSP code for ASM 804. The selected ASM 804 receives startup initialization information from the API 802. Following initialization, after processing each frame of signal data, the ASM 804 checks the FIFO 302, as described above, to determine whether processor RISC0 has any new commands/requests. If so, the DSP 314 executes the new commands using information stored in master manager(s). As described above in conjunction with software architecture 304, software architecture 800 segments CPMs 806 from ASMs 804. During or following selection of an ASM 804, a common operation supported by a CPM 806 can be initiated. ASM 804 calls a specific CPM 806 from the available N CPM modules, CPM_Module1 through CPM_Module_N, and DSP 314 retrieves the address of the called CPM 806. Following completion of the called common processing operation, the called CPM 806 either returns to the calling ASM 804 or calls another CPM module 806. Eventually, control of DSP 314 returns to ASM 804, and ASM 804 provides an output to A/V processor 302 through the API 802.

Table 3 depicts a sample software initialization process for processor RISC0 and DSP 314 in an audio signal processing context. “Kickstart”, as referenced in Table 3, is basically a “GO” message to DSP 314 to both be notified of the incoming compressed data and commands from the processor RISC1. A kickstart event can be considered a “play” message.

TABLE 3

| PROCESSOR RISC0 | | DSP | |
|---|---|---|---|
| 1) | Autodetect bit | 1) | -N/A |
| | stream format of | | |
| | A/V input signal 306. | | |
| 2) | Download DSP code - ASMs | 2) | -N/A |
| | and CPMs into system | | |
| | memory 326. | | |

PRE-KICKSTART INITIALIZATION

| | | | |
|---|---|---|---|
| 3) | Application restart | 3) | Application restart |
| | Setup output clocks | | Initialize internal registers and |
| | | | local memory |
| | | | Initialize local managers and |
| | | | local manager table |
| | | | Initialize |
| | | | Master_Manager_Base buffer |
| | | | Initialize command_FIFO |
| | | | address |
| 4) | Wait for DSP to start-up | 4) | Set start-up initialize bit in the |
| | initialize. | | status register. |
| 5) | Prefill and configuration | 5) | Wait for command from RISC |
| | and/or kick-start command. | | (config change and/or kickstart) |
| | Pre-fill input data FIFO | | |
| | Reconfigure managers (if | | |
| | needed) and/or kick-start DSP | | |
| | by sending commands to the | | |
| | DSP. | | |

POST-KICKSTART INITIALIZATION

| | | | |
|---|---|---|---|
| 6) | N/A | 6) | Process command. |
| | | | Update the managers if |
| | | | requested |
| | | | Enter into decode mode if kick- |
| | | | started |

RUN-TIME DECODE

| | | | |
|---|---|---|---|
| 7) | Enter run-time decode | 7) | Enter run-time decode |
| 8) | Send command if update of | 8) | Update managers if requested |
| | managers required. | | |
| 9) | Run-time decode. | 9) | If sampling frequency changed |
| | | | or input signal bit stream error |
| | | | report to RISC via interrupt. |
| 10) | Interrupt handing (stop data | 10) | Go to DSP step 3. |
| | delivery, service interrupt). | | |
| 11) | Go to processor RISC0 step 3. | 11) | N/A |

In an audio signal processing context, software architecture 800 implements a variety of decoders and common audio post processing applications. For example, if processor RISC0 detects a Dolby® Digital formatted signal, DSP 314 begins processing the digital signal samples using the ASM 804 for Dolby® Digital. If processor RISC0 detects a user command, such as a bass manager change request, then processor RISC0 locates the address of the bass manager and updates it with the new settings. The processor RISC0 then sends a message to DSP that the bass manager settings changed and DSP copies the new settings into a local bass manager. The bass manager CPM executes and returns to the calling of ASM 804. Subsequently, ASM 804 provides PCM output samples of the processed audio input signal.

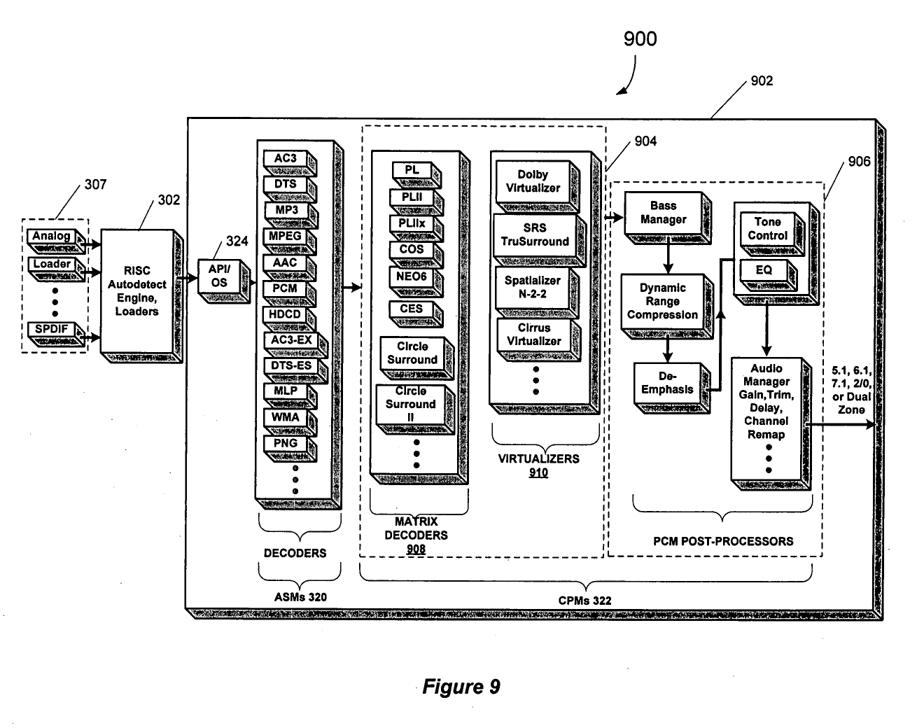

In some instances, A/V system 300 may only use a subset of common processing modules in conjunction with processing a particular input signal. Thus, loading all common processing modules into system memory represents an unnecessary amount of resource overhead expense, particularly in terms of memory and processor usage. In an embodiment of A/V system 300, A/V system 900 depicted in FIG. 9 includes software architecture 902 that partitions a restrictive set 904 of common processing modules from an unrestrictive set 906 of common processing modules. The A/V system 900 loads only the applicable common processing module(s) from the restrictive set 904 into system memory 326 and loads all of the common processing modules from the unrestrictive set 906 into system memory 326. Matrix decoders 908 and virtualizers 910 represent one example of a restrictive set of common processing modules. As previously described, matrix decoders 908 effectively increase the number of input channels in an input audio signal using channel expanding algorithms. Virtualizers 910 reduce the number of audio input channels in an input audio signal when audio equipment supports a lower number of channels. The choice of matrix decoder 908 or virtualizer 910 does not depend upon the type of signal being processed. Nevertheless, A/V system 900 uses only one matrix decoder or virtualizer at a time. A user can select a particular matrix decoder or a particular virtualizer, and/or A/V system 900 can be programmed to automatically select a matrix decoder or virtualizer. A/V system 900 loads all of pulse-code modulation (“PCM”) post-processors 906 because A/V system 900 and/or a user may utilize one or more of the operations supported by PCM post-processors 906 essentially at any time during the processing of an input signal. Because of the on-demand status of PCM post-processors 906, a failure to load all PCM post-processors 906 into system memory 326 typically results in adverse signal processing performance and responsiveness. Thus, by segmenting the CPMs 322 into a restrictive set 904 and unrestrictive set 906, A/V system 900 loads on-demand code into system memory 326, which further enhances the resource utilization efficiency of A/V processor 302 resources.

Thus, the software architecture 304 allows the A/V system 300 to operate using a software architecture efficiently partitioned between application specific modules and a set of compatible common processing modules. Furthermore, the number of CPMs actually loaded into system memory can be reduced by a restricting the number of loaded CPMs to CPMs needed to support on-demand processing operations.

Although the present invention has been described in detail, it should be understood that various changes, substitutions and alterations can be made hereto without departing from the spirit and scope of the invention as defined by the appended claims.

What is claimed is:

1. An audio-video signal processing system having a partitioned software architecture, the system comprising:
a processor; and
a processor readable medium coupled to the processor, the processor readable medium having signal processing code to process an input signal, the signal processing code comprising:
application specific code comprising a plurality of application specific modules, wherein each application specific module includes code to cause the processor to perform at least one application specific operation; and
common processing code comprising a plurality of common processing modules, wherein each common processing module includes code to cause the processor to perform at least one common processing operation and each common processing module is compatible with a plurality of application specific modules.

2. The system of claim 1 wherein the processor is a digital signal processor and the processor readable medium is system memory, the system further comprising:
application specific module (ASM) managers stored in the system memory wherein each ASM manager includes data fields specifying attributes and operational codes; and
common processing module (CPM) managers stored in the system memory wherein each CPM manager includes data fields specifying attributes and operational codes; and
a second processor for processing input data received by the system and having write access to the ASM and CPM managers to correlate information contained by the data fields of the ASM and CPM managers with information;
wherein the digital signal processor has read access to the ASM and CPM managers and can detect changes to the ASM and CPM managers.

3. The system of claim 2 wherein the second processor is a reduced instruction set computer (RISC) processor to process system configuration input data and to control messaging of input configuration data to the digital signal processor.

4. The system of claim 2 further comprising:
a copy of the ASM and CPM managers locally accessible to the digital signal processor to prevent read/write data conflicts.

5. The system of claim 1 wherein the processor is a digital signal processor to process audio signals in accordance with the application specific code and common processing code.

6. The system of claim 1 wherein each ASM module comprises code to decode audio compression formats.

7. The system of claim 6 wherein the audio compression formats are selected from the group comprising: audio compression—3 (AC3), Windows Media Audios (WMA), Windows® Wave (WAV), digital theater sound (DTS), high definition compatible digital (HDCD), moving picture experts group layer—3 audio (MP3), pulse code modulation (PCM), advanced audio coding (AAC), portable networks graphics (PNG), Dolby Digital-EX, Digital Theater Surround-ES, Digital Theater Surround 96/24, WMA-Pro, MP3-Pro, and meridian loss-less packing (MLP).

8. The system of claim 1 wherein each common processing module performs an operation selected from the group comprising: audio management, bass management, tone control, equalization, dynamic range compression, sample rate conversion, matrix decoding, virtualization, and surround sound management.

9. The system of claim 1 wherein the processor readable medium is system memory, the system further comprising code to:
load only common processing modules used for on-demand signal processing.

10. The system of claim 9 wherein only one matrix decoder or one virtualizer is included in the common processing modules used for on-demand signal processing.

11. The system of claim 1 wherein the audio-video signal processing system is a digital video disc processing system.

12. A method of processing data using a processor and software architecture partitioned between application specific modules (ASMs) and common processing modules (CPMs), the method comprising:
receiving input data;
requesting one of the ASMs to perform an application specific operation on the input data;
performing the application specific operation using the requested ASM;
requesting one of the CPMs to perform a common processing operation, wherein each of the CPMs is compatible with a plurality of the ASMs; and
performing the common processing operation using the requested CPM.

13. The method of claim 12 further comprising:
loading into system memory only common processing modules used for on-demand signal processing.

14. The method of claim 13 wherein only one matrix decoder or one virtualizer is loaded into system memory for on-demand processing.

15. The method of claim 12 wherein the input data includes a digital audio signal and requesting one of the ASMs to perform an operation comprises requesting one of the ASMs to decode the digital audio signal.

16. The method of claim 15 wherein the ASMs comprise code to decode audio compression formats.

17. The method of claim 16 wherein the audio compression formats are selected from the group comprising: audio compression—3 (AC3), Windows Media Audio® (WMA), Windows®(D Wave (WAV), digital theater sound (DTS), high definition compatible digital (HDCD), moving picture experts group layer—3 audio (MP3), pulse code modulation (PCM), advanced audio coding (AAC), portable networks graphics (PNG), Dolby Digital-EX, Digital Theater Surround-ES, Digital Theater Surround 96/24, WMA-Pro, MP3-Pro, and meridian loss-less packing (MLP).

18. The method of claim 12 wherein the input data includes a digital audio signal and the common operation is selected from the group comprising: audio management, bass management, tone control, equalization, dynamic range compression, sample rate conversion, and surround sound management.

19. The method of claim 12 wherein requesting one of the ASMs to perform an operation on the input data comprises:
writing a command word in a data buffer specifying parameters of the request;
reading the command word in the data buffer with a digital signal processor; and
updating a manager associated with the requested ASM with at least a subset of the parameters.

20. The method of 18 wherein the data buffer is a first-in-first-out buffer having sufficient size to allow reading processes and writing processes to perform at respective paces.

21. The method of claim 12 wherein the processor comprises a digital signal processor in a digital versatile disk system and the input data comprises digital audio data.

22. An audio/visual system having a software architecture partitioned between application specific modules (ASMs) and common processing modules (CPMs), the system comprising:
means for receiving input data;
means for requesting one of the ASMs to perform an application specific operation on the input data;
means for performing the application specific operation using the requested ASM;
means for requesting one of the CPMs to perform a common processing operation, wherein the CPMs are compatible with a plurality of ASMs; and
means for performing the common operation using the requested.

23. A method of developing a segmented software architecture for an audio/video system, the method comprising:
partitioning software into application specific code and common processing code to cause one or more audio/video processors of the audio/video system to perform predetermined operations, wherein partitioning the software comprises:
generating a plurality of application specific modules, wherein each application specific module consolidates unique code used for at least one of the processor operations; and
generating common processing modules that are compatible with a plurality of application specific modules for performing operations in conjunction with a plurality of application specific modules.

24. The method of claim 23 wherein the one or more audio processors comprise a digital signal processor and a communication processor responsible for communications between the digital signal processor and peripheral components of the audio/visual system, the method further comprising:
associating a manager with each application specific module and each common processing module to store data accessible to the digital signal processor and the communication processor.

25. The method of claim 24 further comprising:
developing code to create a copy of the managers local to the digital signal processor during operation of the audio/video system.

26. The method of claim 23 wherein the application specific modules comprise audio decoders and the common processing code comprises audio post-processing code.

27. A computer program product having code encoded therein to direct a processor to process a signal, the code comprising:
application specific code comprising a plurality of application specific modules, wherein each application specific module includes code to cause the processor to perform at least one application specific operation; and
common processing code comprising a plurality of common processing modules, wherein each common processing module includes code to cause the processor to perform at least one common processing operation and each common processing module is compatible with a plurality of application specific modules.

28. The computer program product of claim 27 wherein the computer readable medium is selected from a the set of a disk, tape or other magnetic, optical, or electronic storage medium and a network, wireline, wireless or other communications medium.

29. The computer program product of claim 27 wherein the code further comprises a manager associated with each application specific module and each common processing module to store data accessible to the processor.

30. The computer program product of claim 27 wherein the application specific code comprises code to decode audio compression formats.

31. The computer program product of claim of claim 30 wherein the audio compression formats are selected from the group comprising: audio compression—3 (AC3), Windows Media Audio® (WMA), Windows® Wave (WAV), digital theater sound (DTS), high definition compatible digital (HDCD), moving picture experts group layer—3 audio (MP3), pulse code modulation (PCM), advanced audio coding (AAC), portable networks graphics (PNG), Dolby Digital-EX, Digital Theater Surround-ES, Digital Theater Surround 96/24, WMA-Pro, MP3-Pro, and meridian loss-less packing (MLP).
